(19) United States
(12) Patent Application Publication
(10) Pub. No.: US 2024/0229339 A1
(43) Pub. Date: Jul. 11, 2024

(54) HOME APPLIANCE HAVING OPENING AND CLOSING FRONT DOOR ASSEMBLY

(71) Applicant: SAMSUNG ELECTRONICS CO., LTD., Suwon-si (KR)

(72) Inventors: Naeyoung PARK, Suwon-si (KR); Hyeonuk NA, Suwon-si (KR)

(73) Assignee: SAMSUNG ELECTRONICS CO., LTD., Suwon-si (KR)

(21) Appl. No.: 18/614,168

(22) Filed: Mar. 22, 2024

Related U.S. Application Data
(63) Continuation of application No. PCT/KR2022/009923, filed on Jul. 8, 2022.

(30) Foreign Application Priority Data
Sep. 30, 2021 (KR) 10-2021-0129624

(51) Int. Cl. D06F 39/14; A47L 15/42

(52) U.S. Cl. CPC D06F 39/14; A47L 15/4265

(57) ABSTRACT

A home appliance including a cabinet; and a door assembly to open and close the cabinet, the door assembly including: a door glass, a glass holder having an opening and supporting the door glass in the opening, a door cover coupled to the glass holder, supporting the door glass in the opening, and forming an outer space inside the door assembly, a door safety on the door cover and forming an inner space inside the door assembly, where a discharge passage in the door assembly connects the inner space to the outer space to discharge air heated in the inner space to the outer space, and the door assembly is configured so that, when the opening is closed, a portion of the door glass protrudes into the cabinet, a portion of the glass holder contacts the cabinet, and the door safety is exposed as a front face of the appliance.

### CROSS-REFERENCE TO RELATED APPLICATIONS

This is a continuation application of International Application No. PCT/KR2022/009923, filed Jul. 8, 2022, which is incorporated herein by reference in its entirety, it being further noted that foreign priority benefit is based upon Korean Patent Application No. 10-2021-0129624, filed Sep. 30, 2021, which is incorporated herein by reference in its entirety.

### TECHNICAL FIELD

The present disclosure relates to a ventilation structure of a door assembly in a home appliance having a front opening/closing door assembly.

### BACKGROUND ART

A washing machine is a home appliance that uses electric power to wash laundry such as clothing and blankets. The washing machine may have an accommodation space in which laundry may be accommodated inside a housing corresponding to a main body. The accommodating space may be referred to as, for example, a washing tub or a cabinet. The washing machine may be classified into a vertical axis washing machine and a horizontal-shaft type of washing machine depending upon an arrangement type of the washing tub. The horizontal-shaft type of washing machine may be also referred to as a drum or front-load washing machine. The drum washing machine may operate, for example, to rotate the washing tub alternately in the clockwise and counterclockwise directions, so that the laundry is caused to move up and down along an inner circumferential surface of the washing tub together with washing water.

The drum washing machine may be provided at the front side thereof with an inlet or opening (hereinafter, referred generally to as “opening”) for loading or unloading the laundry into or out of the washing tub. The opening may be provided with a door or a door assembly (hereinafter, referred generally to as “door assembly”) to rotatably move in a forward/backward direction to open or close the opening.

### DETAILED DESCRIPTION OF THE INVENTION

### Technical Problem

A drum washing machine may support a function of controlling a temperature of washing water based on a type or condition of a laundry. The drum washing machine may generate heat due to rotation of a motor and/or electronic components therein during an operation for washing or dehydration. The heat generated by the temperature and/or operation of the washing water may increase air temperature in a space present in the door assembly of the drum washing machine. In case where such heated air could not be discharged to the outside, its heat flow may be concentrated onto the front of the door assembly.

An embodiment of the present disclosure provides a ventilation structure that allows air to flow in between an interior and an exterior of the door assembly in a home appliance having a front opening/closing door assembly.

### Technical Solution

According to an embodiment of the present disclosure, a home appliance may include a cabinet including an opening, and a door assembly rotatably coupled to the cabinet to open the opening and close the opening. The door assembly may include: a door glass having a rear face and a front face, a glass holder having an opening of the glass holder and at least partially supporting the door glass in the opening of the glass holder by the rear face, a door cover at least partially supporting the door glass in the opening of the glass holder by the front face, and coupled to the glass holder so that the door cover and the glass holder form an outer space having a ring shape around the door glass inside the door assembly, a door safety coupled to the door cover so that the door safety, the door glass, and the door cover form an inner space inside the door assembly. The door assembly may include an inner discharge passage formed in the door assembly that connects the inner space to the outer space formed to discharge air heated in the inner space to the outer space. The door assembly may be configured so that, when the opening is closed by the door assembly, a portion of the door glass protrudes into the cabinet, at least a portion of the glass holder contacts a periphery of the opening, and the door safety is exposed as a front face of the home appliance

An outer discharge passage may be formed in the door assembly to connect the outer space to an outside of the door assembly to discharge the heated air to the outside of the door assembly.

The outer discharge passage may be formed by at least a portion of an inner periphery of a rear face of the glass holder having a protruding shape forming a gap spaced apart from the rear face of the glass holder so that air at the outside of the door assembly is allowed to ventilate the outer space.

The outer discharge passage may be formed by one or more holes passing through a rear face of the glass holder to the outer space.

The outer discharge passage may include: a first outer discharge passage formed by at least a portion of an inner periphery of a rear face of the glass holder having a protruding shape forming a gap spaced apart from the rear face of the glass holder so that air at the outside of the door assembly is allowed to ventilate the outer space, and a second outer discharge passage formed by one or more holes passing through the rear face of the glass holder to the outer space.

The inner discharge passage may be formed by a gap between one end of a support member formed along at least a portion of an inner edge of a rear face of the door cover and an outer periphery of the front face of the door glass.

The home appliance may further include one or more holes formed in a bottom portion of the glass holder to form an inlet passage through which air outside the door assembly is introduced into the outer space.

A material of the door safety may be a transparent plastic or a semi-transparent plastic.

A material of the door safety may be an opaque plastic, and a material of the door cover may be a transparent plastic.

A material of the door safety may be a semi-transparent plastic, and a material of the door cover may be a transparent plastic.

According to an embodiment of the present disclosure, a home appliance may include a home appliance body including a cabinet and an opening, and a door assembly rotatably connected to the home appliance body to open the opening and close the opening. The door assembly may include: a door safety exposed to an outside of the home appliance, a door cover coupled to the door safety, a door glass coaxial with and coupled to the door cover, and a glass holder coupled to the door glass, and including a ring-shaped rear face facing the cabinet when the door assembly is closed and an outer circumferential surface extending along an edge of the ring-shaped rear face. The glass holder may include an air discharge passage structure including at least one first opening formed between the door glass and the glass holder through which air in an inner space of the door assembly escapes to an outside of the door assembly.

The at least one first opening may include a plurality of first openings formed at equal intervals along a horizontal direction of the ring-shaped rear face.

The glass holder may further include an air inlet passage structure on the outer circumferential surface to allow air at an outside of the door assembly to be introduced into the inner space.

The air inlet passage structure may be formed on a lower end of the outer circumferential surface that is opposite to the air discharge passage structure.

The air inlet passage structure may include one or more second openings.

The air inlet passage structure may include a plurality of second openings formed at equal intervals along the outer circumferential surface.

The door assembly may further include a first air discharge passage on a side of an edge thereof.

The first air discharge passage may be configured such that hot internal air is introduced to the inner space through a first gap between an edge of the door cover and an edge of the door glass, and the introduced hot internal air exits the inner space to the outside of the door assembly through a second gap formed between the edge of the door glass and the glass holder.

A material of the door safety may be an opaque plastic, and a material of the door cover may be a transparent plastic.

A material of the door safety may be a semi-transparent plastic, and a material of the door cover may be a transparent plastic.

### Advantageous Effects

According to an embodiment of the present disclosure, the front opening/closing door assembly provided in the home appliance may reduce the internal temperature of the door assembly, by allowing heated internal air to be discharged to the outside and allowing a relatively lower temperature of external air to be drawn in.

### BRIEF DESCRIPTION OF DRAWINGS

FIG. 1 is a perspective view of an example home appliance having a front opening/closing door assembly according to an embodiment.

FIG. 2 is an exploded perspective view of a door assembly provided in a home appliance according to an embodiment.

FIG. 3A is a front perspective view of a door assembly provided in a home appliance according to an embodiment.

FIG. 3B is a rear perspective view of a door assembly provided in a home appliance according to an embodiment.

FIG. 3C is a rear view of a door assembly provided in a home appliance according to an embodiment.

FIG. 3D is a plan view of a door assembly provided in a home appliance according to an embodiment.

FIG. 3E is a bottom view of a door assembly provided in a home appliance according to an embodiment.

FIG. 3F is a right cross-sectional view of a door assembly provided in a home appliance according to an embodiment.

FIG. 4A is a detailed view of a part A shown in FIG. 3C.

FIG. 4B is a cross-sectional view of a part A shown in FIG. 3D.

FIG. 5 is a more detailed view of a part B shown in FIG. 3E.

FIG. 6 is a more detailed view of a part C shown in FIG. 3F according to an embodiment.

FIG. 7 is a more detailed view of a part C shown in FIG. 3F according to an embodiment.

FIG. 8 is a perspective view of a part D shown in FIG. 3F according to an embodiment.

### MODE FOR CARRYING OUT THE INVENTION

Hereinafter, various embodiments will be described in detail with reference to the accompanying drawings. In the following description, specific details such as detailed configurations and components will be provided only to help a general understanding of embodiments of the disclosure. Therefore, it would be apparent to those skilled in the art that various changes and modifications may be made without departing from the scope and spirit of the disclosure. Further, descriptions of well-known features and configurations may be omitted for clarity and brevity.

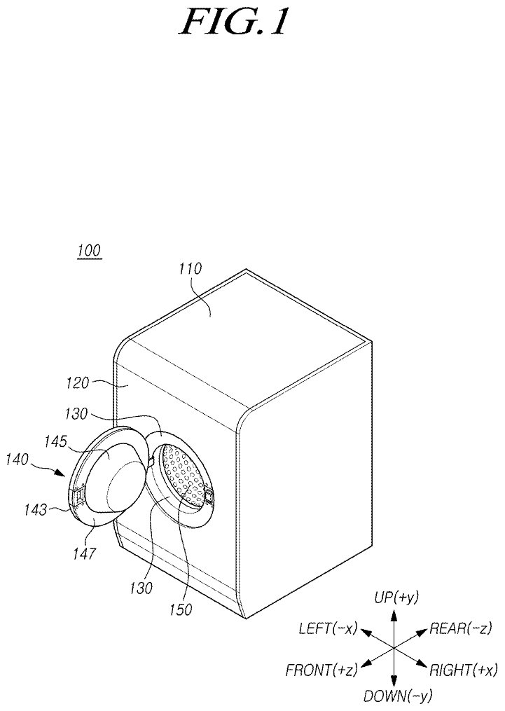

FIG. 1 is a perspective view of an exemplary home appliance 100 including a front opening/closing door assembly according to an embodiment.

Referring to FIG. 1, the home appliance 100 including the front opening/closing door assembly may be a home appliance having a door assembly installed on its front panel to be opened by pulling forward or closed by pushing back. The home appliance 100 including the front opening/closing door assembly may be, for example, a home appliance such as e.g., a drum washing machine, a drum dryer, a drum drying/washing machine, or a dishwasher. Hereinafter, for the sake of convenience, description will be made of a drum washing machine, which is an example of the home appliance 100 having the front opening/closing door assembly. However, embodiments proposed in the disclosure may be also applied to any home appliance having a front opening/closing door assembly, such as e.g., a drum dryer, a drum drying/washing machine, or a dishwasher, with the same or like structure or readily adaptable modification to the drum washing machine.

According to an embodiment, the drum washing machine 100 may include a cabinet that rotates about an axis (e.g., z-axis) substantially horizontal to a mounting surface of the washing machine, that is, a bottom surface, unlike a vertical axis washing machine with the cabinet rotating about an axis (e.g., y-axis) substantially perpendicular to the mounting surface. A rotation axis of the cabinet does not necessarily have to be horizontal to the mounting surface. For example, the rotating axis of the cabinet may be arranged to be inclined by a predetermined angle with respect to an axis horizontal to the mounting surface.

According to an embodiment, the drum washing machine 100 may include a housing 110 forming an outer appearance, a front panel 120 disposed on a front face (+z direction) of the housing 110, a door assembly 140 provided on the front panel 120, or a cabinet 150 rotatably installed inside the housing 110. The housing 110 may have a substantially hexahedral shape. The front panel 120 may be provided with an opening 130 for loading laundry into the cabinet 150 or unloading laundry from the cabinet 150.

According to an embodiment, the door assembly 140 may be coupled to the front panel 120 of the housing 110 to open or close the opening 130 as required. The door assembly 140 may be arranged to rotatably move between a closed position for closing the opening 130 or an open position for opening the opening 130. The door assembly 140 may be coupled to, for example, one side of the opening 130 by means of a hinge. The door assembly 140 may include a handle. The handle may be provided to be gripped by a user to open or close the door assembly 140, in use.

According to an embodiment, the door assembly 140 may include a door safety (not shown in FIG. 1), a door cover 143, a door glass 145, or a glass holder 147. The door glass 145 may be made of, for example, an injection molding of a non-glass, transparent plastic material. For example, the door glass 145 may be configured such that a portion of the door glass 145 protrudes into the cabinet 150 when the opening 130 is closed by the door assembly 140. The glass holder 147 may support, for example, the door glass 145. For example, at least a portion of the glass holder 147 may be configured to be in contact with a periphery of the opening 130 when the opening 130 is closed by the door assembly 140. The door cover 143 may be configured, for example, to support the door glass 145 and be coupled to the glass holder 147. The door safety may be coupled to, for example, the door cover 143 and may be configured to be exposed to the front panel 120 in a state of the opening 130 being closed by the door assembly 140.

As used in the following description, the terms such as e.g., “front end”, “rear end”, “lower part”, “upper end”, “lower end”, or the like are defined on the basis of the drawings, and the shape and position of each component may not be limited by those terms.

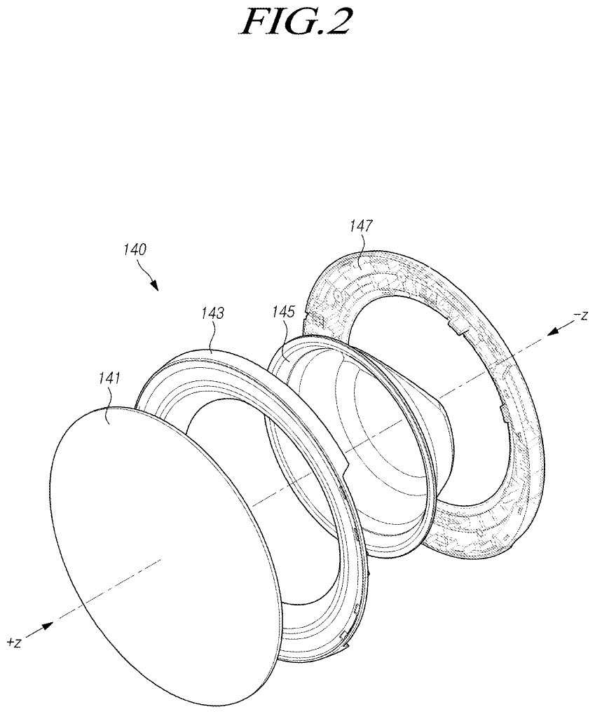

FIG. 2 is an exploded perspective view of a door assembly (e.g., the door assembly 140 of FIG. 1) provided in a home appliance (e.g., the drum washing machine 100 of FIG. 1) according to an embodiment.

Referring to FIG. 2, the door assembly 140 according to an embodiment may include a door safety 141, a door cover 143, a door glass 145, or a glass holder 147.

The door safety 141 may have a disk shape. The door safety 141 may be provided on a front face of the door assembly 140 to implement its front exterior design and improved internal insulation. The door safety 141 may be made of, for example, a transparent or opaque plastic material, or may be made of a semi-transparent plastic material. The door safety 141 may be made, for example, by a plastic injection molding.

The door cover 143 may have a ring shape. The door cover 143 may implement front exterior design and increased durability of the door assembly 140. The door cover 143 may be made, for example, by a plastic injection molding. The door safety 141 may be attached to the door cover 143 along an outer periphery of one side (e.g., a front face) provided in a forward direction (in +z direction). The door cover 143 may be configured such that the glass holder 147 may be attached to the door cover 143 along an outer periphery of the other side (e.g., a rear face) provided in a backward direction (in -z direction). On the rear face of the door cover 143 may be provided, when coupled to the glass holder 147, a support member of a protruding shape in its entire or partial section facing an outer periphery of a front face of the door glass 145. Before being coupled to the rear face of the door cover 143, the glass holder 147 may be inserted into a hole or opening such that an outer circumferential surface of the door glass 145 is in close contact with the hole or opening. The support member may have a loosened structure so as not to be in contact with the door glass 145 either evenly or unequally in some or entire sections thereof. This structure may create a passage through which air in the inner space is discharged into the outer space or air in the outer space is introduced into the inner space, inside the door assembly 140.

The door glass 145 may have a hemispherical shape in which a front face (in +z direction) is opened and a rear face (in −z direction) is blocked and protrudes. The hemispherical shaped door glass 145 may have a certain volume of space (hereinafter, referred to as “inner space”) in its inside. The door glass 145 may block the opening 130 formed in the front panel 120 of the housing (e.g., the housing 110 of FIG. 1). In such a circumstance, the inside of the home appliance (e.g., the cabinet 150 of FIG. 1) may be sealed from its outside. A protruding portion of the rear face of the door glass 145 may be inserted into a hole or an opening of the glass holder 147 to be coupled to the glass holder 147. In this case, an edge member formed along an outer periphery of the front face of the door glass 145 may come into contact with the entire or part of the circumference corresponding to an outer periphery of the hole or opening in the glass holder 147. The door glass 145 may be made of, for example, an injection molding of a non-glass transparent plastic material.

The glass holder 147 may be formed of a ring shape having an inner hole therein. The glass holder 147 may form a rear face design of the door assembly 140 and implement improved durability thereof. The door glass 145 may be inserted into the hole of the glass holder 147. The glass holder 147 with the door glass 145 inserted thereto may be coupled such that a front edge thereof faces a rear edge of the door cover 143. The glass holder 147 may be made, for example, by a plastic injection molding.

According to an embodiment, the door assembly 140 may have a structure in which the door safety 141, the door cover 143, the door glass 145, or the glass holder 147 are sequentially coupled in an inward direction (+z→−z) from the outside of the opening (e.g., the opening 130 of FIG. 1) to the inside thereof. The door safety 141 may be coupled to the door cover 143 to provide a front face of the door assembly 140. The door glass 145 may be coupled to the glass holder 147 to provide a rear face of the door assembly 140.

According to an embodiment, a rear side of the door cover 143 may be provided with first coupling members (e.g., coupling bosses in which screw holes are formed) along its outer periphery. A front side of the glass holder 147 may be provided with second coupling members (e.g., coupling holes) along its outer periphery at positions corresponding to the positions of the first coupling members provided on the rear side of the door cover 143. The door cover 143 and the glass holder 147 may have a ring shape. The first coupling members provided on the rear side of the door cover 143 may be respectively coupled one-to-one with the second coupling members provided on the front side of the glass holder 147. The door glass 145 having a substantially hemispherical shape may be inserted into the opening of the glass holder 147 coupled to the door cover 143. Thus, the door glass 145 may be fixed between the door cover 143 coupled by the first and second coupling members and the glass holder 147. The door safety 141 may be fitted onto the front face of the door cover 143, which is not coupled to the glass holder 147, in the form of cover, or may be coupled thereto by means of an adhesive material at its outer periphery.

The door assembly 140 that has the coupling structure according to the above-described proposal may have at least one air discharge passage and at least one air inlet passage, owing to such a coupling of all the components. Air heated inside the door assembly 140 may be discharged out of the door assembly 140 through the at least one discharge passage. Air outside the door assembly 140 may be introduced into the door assembly 140 through the at least one inlet passage.

The at least one discharge passage of the door assembly 140 having the coupling structure according to the above-described proposal may have a first inner space (hereinafter, referred to as an “inner space”) and a second inner space (hereinafter, referred to as an “outer space”). The inner space may be formed, for example, by coupling of the door safety 141, the door cover 143, or the door glass 145. The outer space may be formed, for example, by coupling of the door cover 143 and the glass holder 147. Air heated in the inner space may be discharged to the outer space through at least one inner discharge passage. The heated air introduced from the inner space to the outer space through the inner discharge passage may be discharged to the outside of the door assembly 140 through at least one outer discharge passage.

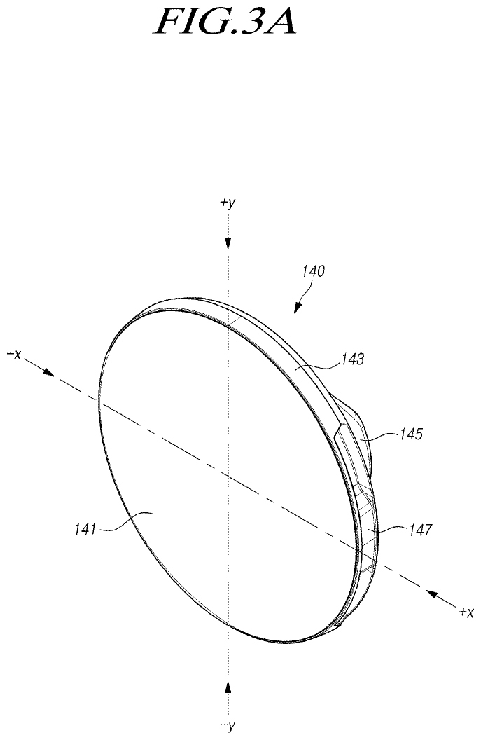

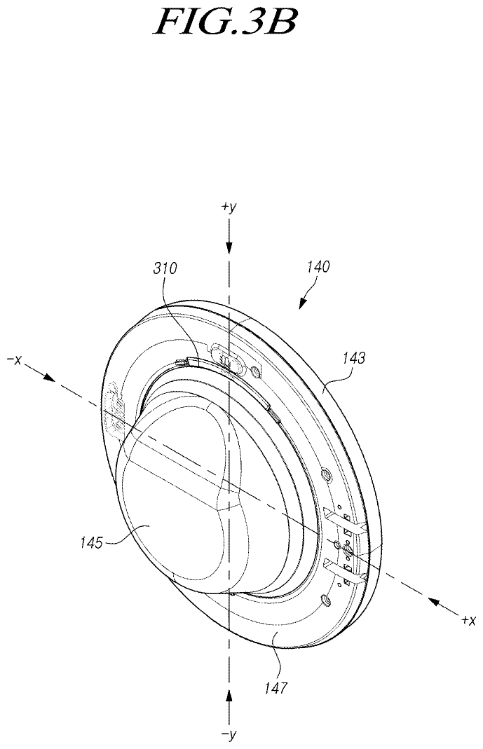

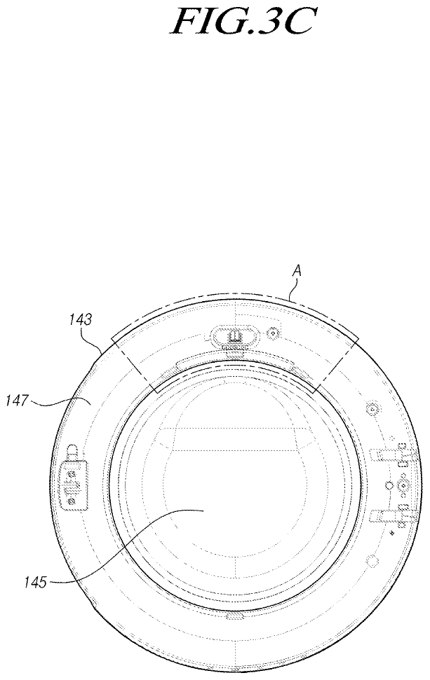

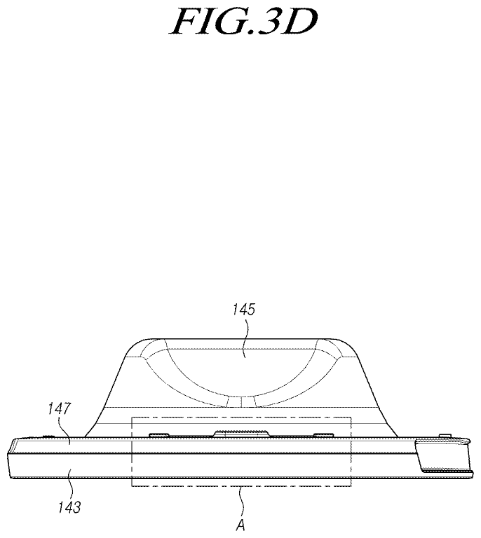

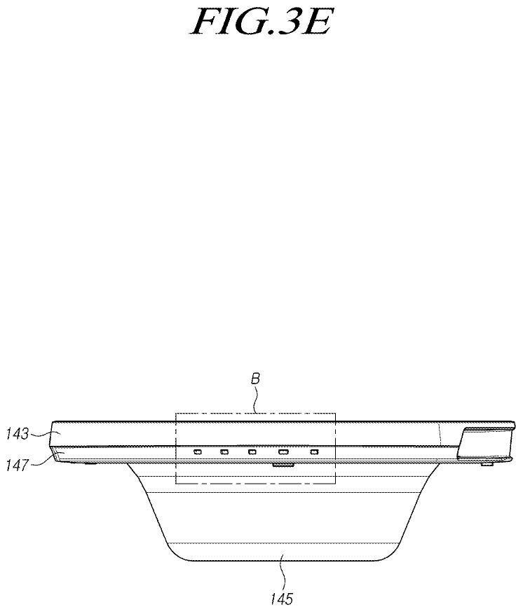

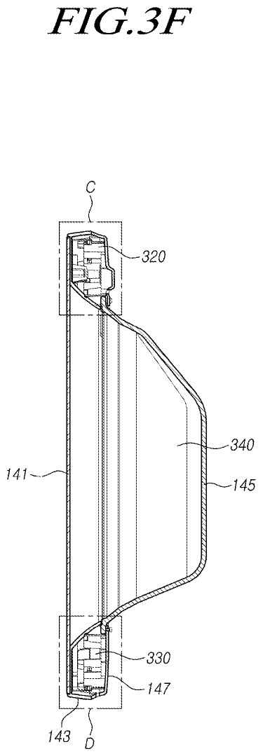

FIG. 3A is a front perspective view of a door assembly (e.g., the door assembly 140 of FIG. 1) provided in a home appliance (e.g., the drum washing machine 100 of FIG. 1) according to an embodiment.

Referring to FIG. 3A, the door assembly 140 may be provided by coupling the door cover 143 to which the door safety 141 is coupled to the front face or the glass holder 147 to which the door glass 145 is inserted.

FIG. 3B is a rear perspective view of a door assembly (e.g., the door assembly 140 of FIG. 1) provided in a home appliance (e.g., the drum washing machine 100 of FIG. 1) according to an embodiment.

Referring to FIG. 3B, a structure 310 may be formed on the rear face of the glass holder 147 into which the door glass 145 is inserted and coupled to the door cover 143, for providing ventilation to and from the inside of the door assembly 140. The structure 310 may have a structure providing for one or more discharge passages (e.g., at least one outward discharge passage) for discharging heated air from the inside the door assembly 140 to the outside thereof.

FIG. 3C is a rear view of a door assembly (e.g., the door assembly 140 of FIG. 1) provided in a home appliance (e.g., the drum washing machine 100 of FIG. 1) according to an embodiment.

Referring to FIG. 3C, according to an embodiment, a discharge passage structure (hereinafter, referred to as a “first passage structure”) serving as an outlet passage (e.g., an outer discharge passage) for discharging air inside the door assembly to the outside may be provided in a partial area (part A) of the rear face of the glass holder 147. The first passage structure may be formed of at least one of a protruding structure and/or a hole structure. The drawing illustrates the first passage structure formed with both types of structures. However, for the purpose of implementing with the disclosure, it is not necessary for the first passage structure to essentially have both types of outward discharge passages. For example, the objective of the present disclosure may be achieved by only providing either one of the two types of outward discharge passages.

The first passage structure of protruding type may be formed to protrude, for example, from the rear face of the glass holder 147. Due to such protrusion from the first passage structure, the space formed on the rear face of the glass holder 147 may serve as a discharge passage, in particular, an outward discharge passage, through which air heated inside the door assembly 140 is to be discharged outward. The hole-type of first passage structure may be formed, for example, by holes disposed at either equal intervals or unequal intervals on the rear face of the glass holder 147. The holes forming the first passage structure may be discharge passages through which air heated inside the door assembly 140 is to be discharged out, in particular, outward discharge passages.

According to an embodiment, the first passage structure formed in the glass holder 147 may be preferably opened to the outside (e.g., outside of the home appliance) even in a state of the door assembly 140 closing the opening (e.g., the opening 130 of FIG. 1) of the home appliance 100, or may be disposed at a position where a connection passage to the outside is arranged.

According to an embodiment, considering that heated air tends to ascend, it may be preferable that the passage structure including the first passage structure forming a discharge passage of the door assembly 140 is disposed above the glass holder 147 (+y direction).

According to an embodiment, an inlet passage structure (hereinafter, referred to as a “second passage structure”) forming an inlet passage, which is a passage through which outside air of the door assembly 140 may be introduced into the glass holder 147, may be provided in a partial area (part B) at the rear face of the glass holder 147. The second passage structure may have substantially a hole structure. The second passage structure of the hole structure may be, for example, one or more holes provided on the rear face of the glass holder 147 to allow outside air to flow into the door assembly 140.

According to an embodiment, the first and second passage structures formed in the glass holder 147 may be preferably opened to the outside (e.g., the outside of the home appliance) even in a state of the door assembly 140 closing the opening (e.g., the opening 130 of FIG. 1) of the home appliance 100, or may be preferably disposed at a position where a connection passage to the outside is arranged.

FIG. 3D is a plan view of a door assembly (e.g., the door assembly 140 of FIG. 1) provided in a home appliance (e.g., the drum washing machine 100 of FIG. 1) according to an embodiment.

Referring to FIG. 3D, the door assembly 140 may be seen as being assembled in the order of the door cover 143, the door glass 145, or the glass holder 147, when viewed from its front side. A first passage structure serving as a discharge passage for discharging air inside the door assembly 140 to the outside may be provided in a portion A of the rear face of the glass holder 147 making up the door assembly 140. When an inner space and an outer space exist inside the door assembly 140, the discharge passage made up by the first passage structure may include at least one inner discharge passage and at least one outer discharge passage. The at least one inner discharge passage may be a passage through which air heated in the inner space of the door assembly 140 is discharged to the outer space of the door assembly 140. The at least one outer discharge passage may be a passage through which heated air introduced into an outer space of the door assembly 140 through the at least one inner discharge passage is discharged to the outside of the door assembly 140.

FIG. 3E is a bottom view of a door assembly (e.g., the door assembly 140 of FIG. 1) provided in a home appliance (e.g., the drum washing machine 100 of FIG. 1) according to an embodiment.

Referring to FIG. 3E, when viewed from the front side, the door assembly 140 may be seen as being assembled in the order of the door glass 145, the glass holder 147, or the door cover 143. One or more holes serving as an inlet passage through which air is introduced into the door assembly 140 may be disposed in a portion B of the lower face of the glass holder 147, which is seen when viewed from below the door assembly 140. The one or more holes may be formed to penetrate the glass holder 147 to be connected to an inner space of the door assembly 140.

FIG. 3F is a right cross-sectional view of a door assembly (e.g., the door assembly 140 of FIG. 1) provided in a home appliance (e.g., the drum washing machine 100 of FIG. 1) according to an embodiment.

Referring to FIG. 3F, the outer periphery on the rear face of the door safety 141 may be coupled to contact the outer edge (outer periphery) on the front face of the door cover 143 having a ring shape. The outer edge (outer periphery) on the rear face of the door cover 143 may be coupled to contact the outer edge (outer periphery) on the front face of the glass holder 147. An inner edge (inner periphery) on the rear face of the door cover 143 may be formed to face the front edge of the door glass 145.

According to an embodiment, the inner edge (inner periphery) on the rear face of the door cover 143 may be in contact with the front edge of the door glass 145 in some sections, or may not be entirely in contact with the front edge of the door glass 145. This is to create a gap between the inner edge (inner periphery) on the rear face of the door cover 143 and the front edge of the door glass 145. The gap may be an inner discharge passage (or a first inner passage) that allows heated air from the inner space (or the first space) 340 made inside the door glass 145 to escape to the first outer space (or the second space) 320, or may be an inner inlet passage (or a second inner passage) that allows a relatively low temperature of outside air from the second outer space (or the third space) 330 to flow into the inner space 340. The inner discharge passage may be included in a first internal structure C formed at an upper end of the door assembly 140. The inner inlet passage may be included in a second internal structure D formed at a lower end of the door assembly 140. The first outer space (or the second space) 320 and the second outer space (or the third space) 330 may be the same space formed along a circular tube-shaped edge by coupling of the door cover 143 and the glass holder 147, differing only in positions.

According to an embodiment, the inner edge (inner periphery) of the front face of the glass holder 147 may come into contact in some sections with the rear edge of the door glass 145. Such contact only in some sections is due to the outer discharge passage formed by the structure 310 of FIG. 3B. The outer discharge passage may act as a passage for expelling the heated air in the second space 320, which is an outer space, to the outside. The outer discharge passage may be included in the first internal structure C formed at an upper end of the door assembly 140.

According to an embodiment, one or more holes may be provided in the outer periphery of the glass holder 147 for an outer inlet passage. The one or more holes to be used as the outer inlet passage are shown in the part B of FIG. 3E. The outer inlet passage may serve as a passage for introducing outside air having a relatively low temperature into the second outer space (or the third space) 330. The outer inlet passage may be included in the second internal structure D formed at a lower end of the door assembly 140.

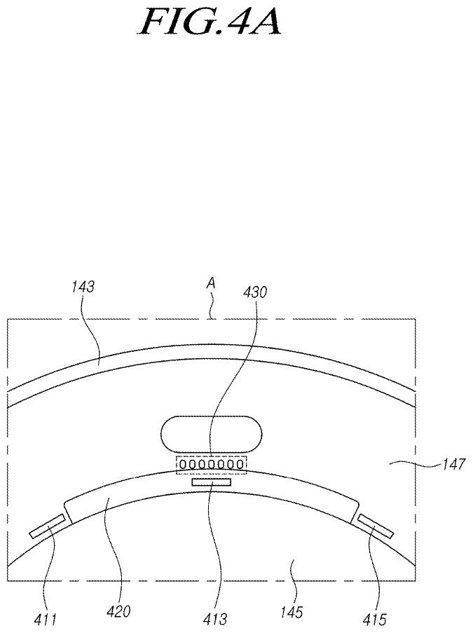

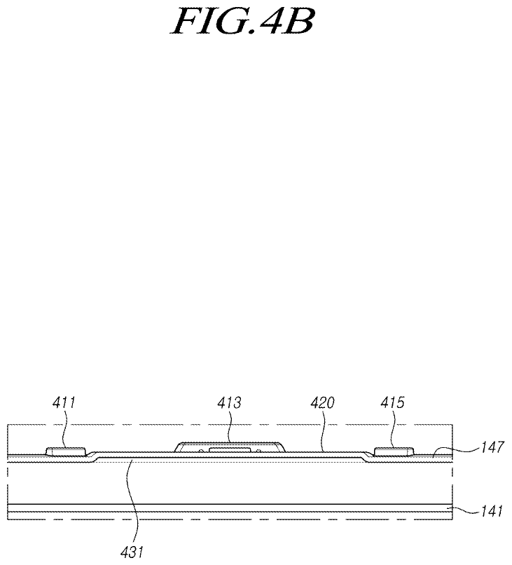

FIG. 4A illustrates a more detailed view of a part A shown in FIG. 3C.

Referring to FIG. 4A, in a partial area (part A) of the rear face of the glass holder 147 making up the door assembly 140 is provided first passage structures 420 and 430 forming an outer discharge passage for discharging the air heated inside the door assembly 140 to the outside. A plurality of supports (411, 413, 415) arranged along the inner periphery of the glass holder 147 may support the glass holder 147 inward of the door assembly 140.

According to an embodiment, a protruding structure 420 of the first passage structures 420 and 430 may be configured to have protrusion structure. The protruding structure 420 may be formed to protrude from the rear face of the glass holder 147 so as to create a gap spaced apart from the rear face of the glass holder 147. The gap made by the protruding structure 420 may be an outer discharge passage through which air heated in the door assembly 140 is discharged to the outside.

According to an embodiment, a hole structure 430 of the first passage structures 420 and 430 may include one or more holes arranged, as an outer discharge passage, on the rear face of the glass holder 147. The one or more holes provided in the outer discharge passage may be provided to discharge air heated in the door assembly 140 to the outside.

In the above-described drawings, both the protruding structure 420 and the hole structure 430 having different structures are illustrated. However, for the purpose of achieving according to the present disclosure, it is not necessary to have the two structures essentially. That is to say, if at least one of the two structures 420 and 430 is provided, the object to be achieved in the disclosure may be sufficiently obtained.

FIG. 4B is a cross-sectional view of a part A shown in FIG. 3D.

Referring to FIG. 4B, a protruding structure 420 (e.g., the protruding structure 420 of FIG. 4A) may be provided in a partial area (part A) of the rear face of the glass holder 147 making up the door assembly 140. The protruding structure 420 protruding from the rear face of the glass holder 147 may have a gap 431 corresponding to a difference between a height at which the protrusion begins and the protruding height. The gap 431 may serve as an outer discharge passage through which air heated in the door assembly 140 is discharged out of the door assembly 140. A plurality of supports (411, 413, 415) may be arranged at equal intervals to support the glass holder 147 inward of the door assembly 140.

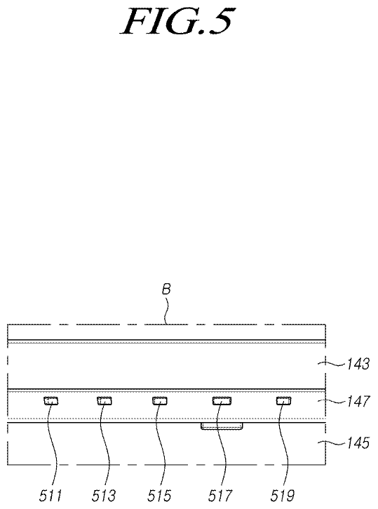

FIG. 5 illustrates a more detailed view of a part B shown in FIG. 3E.

Referring to FIG. 5, one or more holes (511, 513, 515, 517, 519) may be provided in some sections of an outer circumferential surface of the glass holder 147 making up the door assembly 140. The one or more holes (511, 513, 515, 517, 519) may pass through the glass holder 147 to reach the inner space of the door assembly 140. The one or more holes (511, 513, 515, 517, 519) may be disposed, for example, at equal intervals (equidistantly spaced) or unequal intervals at a lower end (−y direction) of the outer circumferential surface of the glass holder 147. The one or more holes (511, 513, 515, 517, 519) may serve as an outer inlet passage through which air outside of the door assembly 140 is introduced into the door assembly 140.

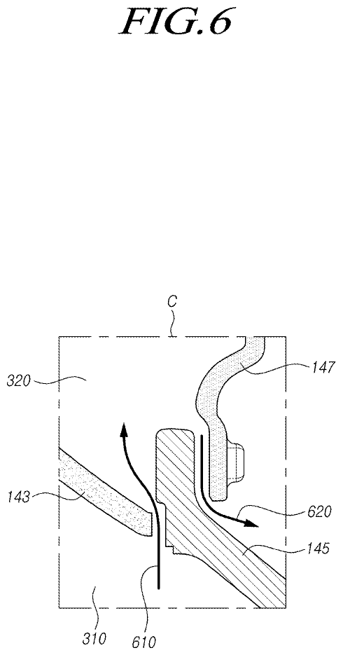

FIG. 6 illustrates a more detailed view of a part C shown in FIG. 3F according to an embodiment.

Referring to FIG. 6, the door assembly 140 may include at least one of an inner discharge passage 610 or an outer discharge passage 620 to discharge the air heated therein to the outside. The air heated in the inner space (or the first space) 340 of the door assembly 140 may escape to the outer space (or the second space) 320 via the inner discharge passage 610. The air in the outer space 320 may escape out of the door assembly 140 through the outer discharge passage 620.

According to an embodiment, the inner discharge passage 610 may be established by a gap spaced apart between the door glass 145 and the support member formed on the entire or part of the outer periphery on the rear face of the door cover 143.

According to an embodiment, the outer discharge passage 620 may be established by a protruding structure (e.g., the protruding structure 420 of FIG. 4A) having a protruding shape in a partial area (part A) of the rear face of the glass holder 147. For example, the protruding structure 420 may establish the outer discharge passage 620 by a gap spaced apart upward from the rear face of the glass holder 147.

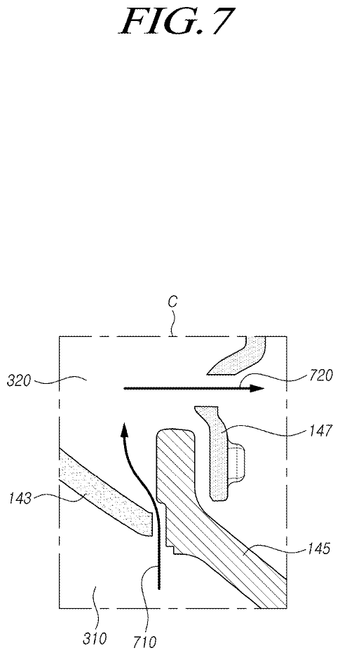

FIG. 7 illustrates a more detailed view of a part C shown in FIG. 3F according to an embodiment.

Referring to FIG. 7, the door assembly 140 may include at least one of an inner discharge passage 710 or an outer discharge passage 720 to discharge the air heated therein to the outside. The air heated in the inner space (or the first space) 340 of the door assembly 140 may escape to the outer space (or the second space) 320 via the inner discharge passage 710. The air in the outer space 320 may escape out of the door assembly 140 via the outer discharge passage 720.

According to an embodiment, the inner discharge passage 710 may be established by a gap spaced apart between the door glass 145 and the support member formed on the entire or part of the outer periphery on the rear face of the door cover 143.

According to an embodiment, the outer discharge passage 720 may be established by one or more holes (e.g., the hole structure 430 of FIG. 4A) provided in a partial section (part A) of the outer circumferential surface on the rear face of the glass holder 147. The one or more holes may penetrate the glass holder 147 to reach the outer space 320 of the door assembly 140.

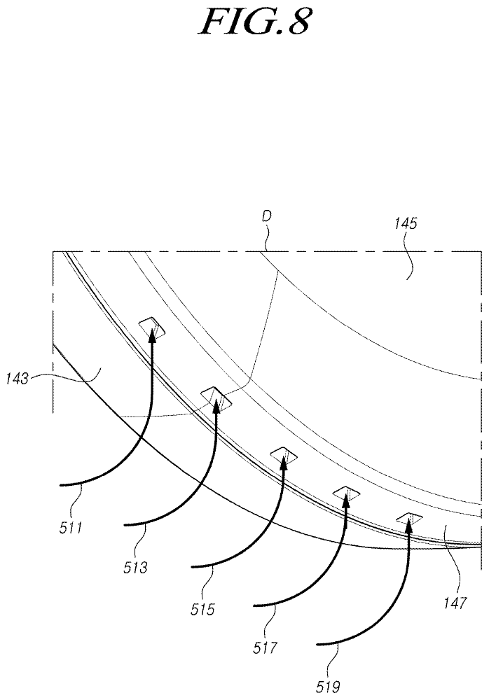

FIG. 8 is a perspective view of a part B shown in FIG. 3C.

Referring to FIG. 8, one or more holes (e.g., the one or more holes (511, 513, 515, 517, 519) of FIG. 5) may be provided in a partial area (part B) of a bottom surface of the glass holder 147 making up the door assembly 140, which serves as an outer inlet passage through which air outside the door assembly 140 is introduced inside of it. The one or more holes (511, 513, 515, 517, 519) may be formed to penetrate a bottom surface of the glass holder 147 to reach the inner space (e.g., the second outer space 330 of FIG. 3F) of the door assembly 140. The one or more holes (511, 513, 515, 517, 519) may serve as an outer inlet passage making up an inlet passage through which exterior air of a relatively low temperature is introduced into the door assembly 140.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled to the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A home appliance, comprising:
a cabinet including an opening; and
a door assembly rotatably coupled to the cabinet to open the opening and close the opening,
the door assembly including:
a door glass having a rear face and a front face,
a glass holder having an opening of the glass holder and at least partially supporting the door glass in the opening of the glass holder by the rear face,
a door cover at least partially supporting the door glass in the opening of the glass holder by the front face, and coupled to the glass holder so that the door cover and the glass holder form an outer space having a ring shape around the door glass inside the door assembly,
a door safety coupled to the door cover so that the door safety, the door glass, and the door cover form an inner space inside the door assembly, and
wherein an inner discharge passage formed in the door assembly connects the inner space to the outer space to discharge air heated in the inner space to the outer space, and
wherein the door assembly is configured so that, when the opening is closed by the door assembly, a portion of the door glass protrudes into the cabinet, at least a portion of the glass holder contacts a periphery of the opening, and the door safety is exposed as a front face of the home appliance.

2. The home appliance of claim 1, wherein an outer discharge passage formed in the door assembly connects the outer space to an outside of the door assembly to discharge the heated air to the outside of the door assembly.

3. The home appliance of claim 2, wherein the outer discharge passage is formed by at least a portion of an inner periphery of a rear face of the glass holder having a protruding shape forming a gap spaced apart from the rear face of the glass holder so that air at the outside of the door assembly is allowed to ventilate the outer space.

4. The home appliance of claim 2, wherein the outer discharge passage is formed by one or more holes passing through a rear face of the glass holder to the outer space.

5. The home appliance of claim 2, wherein the outer discharge passage includes:
a first outer discharge passage formed by at least a portion of an inner periphery of a rear face of the glass holder having a protruding shape forming a gap spaced apart from the rear face of the glass holder so that air at the outside of the door assembly is allowed to ventilate the outer space, and
a second outer discharge passage formed by one or more holes passing through the rear face of the glass holder to the outer space.

6. The home appliance of claim 1, wherein the inner discharge passage is formed by a gap between one end of a support member formed along at least a portion of an inner edge of a rear face of the door cover and an outer periphery of the front face of the door glass.

7. The home appliance of claim 1, further comprising:
one or more holes formed in a bottom portion of the glass holder to form an inlet passage through which air outside the door assembly is introduced into the outer space.

8. The home appliance of claim 1, wherein a material of the door safety is a transparent plastic or a semi-transparent plastic.

9. The home appliance of claim 1, wherein a material of the door safety is an opaque plastic, and a material of the door cover is a transparent plastic.

10. The home appliance of claim 1, wherein a material of the door safety is a semi-transparent plastic, and a material of the door cover is a transparent plastic.

11. A home appliance, comprising:
a home appliance body including a cabinet and an opening; and
a door assembly rotatably connected to the home appliance body to open the opening and close the opening;
the door assembly including:
a door safety exposed to an outside of the home appliance,
a door cover coupled to the door safety,
a door glass coaxial with and coupled to the door cover, and
a glass holder coupled to the door glass, and including a ring-shaped rear face facing the cabinet when the door assembly is closed and an outer circumferential surface extending along an edge of the ring-shaped rear face,
wherein the glass holder comprises an air discharge passage structure including at least one first opening formed between the door glass and the glass holder through which air in an inner space of the door assembly escapes to an outside of the door assembly.

12. The home appliance of claim 11, wherein the at least one first opening includes a plurality of first openings formed at equal intervals along a horizontal direction of the ring-shaped rear face.

13. The home appliance of claim 11, wherein the glass holder further includes an air inlet passage structure on the outer circumferential surface to allow air at an outside of the door assembly to be introduced into the inner space.

14. The home appliance of claim 13, wherein the air inlet passage structure is formed on a lower end of the outer circumferential surface that is opposite to the air discharge passage structure.

15. The home appliance of claim 14, wherein the air inlet passage structure includes one or more second openings.

16. The home appliance of claim 15, wherein the one or more second openings include a plurality of second openings formed at equal intervals along the outer circumferential surface.

17. The home appliance of claim 11, wherein the door assembly further includes a first air discharge passage on a side of an edge thereof.

18. The home appliance of claim 17, wherein the first air discharge passage is configured such that hot internal air is introduced to the inner space through a first gap between an edge of the door cover and an edge of the door glass, and the introduced hot internal air exits the inner space to the outside of the door assembly through a second gap formed between the edge of the door glass and the glass holder.

19. The home appliance of claim 11, wherein a material of the door safety is an opaque plastic, and a material of the door cover is a transparent plastic.

20. The home appliance of claim 11, wherein a material of the door safety is a semi-transparent plastic, and a material of the door cover is a transparent plastic.
